(19) United States
(12) Patent Application Publication
(10) Pub. No.: US 2007/0200673 A1
(43) Pub. Date: Aug. 30, 2007

(54) Apparatus and Method for Controlling and Monitoring Access to a Storage Container

(76) Inventors: Bryan W. Godwin, Round Rock, TX (US); Sean V. Howell, Austin, TX (US); James M. Canter, Austin, TX (US); Garrett R. Lewis, Austin, TX (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/425,579

(22) Filed: Jun. 21, 2006

Related U.S. Application Data
(60) Provisional application No. 60/772,744, filed on Feb. 13, 2006.

(51) Int. Cl. G05B 19/00

(52) U.S. Cl. 340/5.73; 340/5.92; 340/5.3

(57) ABSTRACT

A panel having a plurality of receptacles may be disposed in a storage container. A plurality of inserts may be releasably engaged with respective receptacles. One or more valuable object may be attached to each insert. One of the valuable objects may be a key to provide access to remotely located equipment or other types of enclosures. An electronic controller may be provided to monitor and keep a record of each time an insert is removed from and returned to one of the receptacles. The electronic controller may monitor and record possible tampering with the panel. The electronic controller may be operable to communicate with remotely located equipment, handheld devices and/or a network operations center. If the valuable object is a key for a lock associated with remotely located equipment, the electronic controller may also monitor and record each time the remotely located equipment is opened and closed.

### RELATED APPLICATION

This application claims the benefit of U.S. provisional application No. 60/772,744 entitled “Apparatus And Method For Controlling And Monitoring Access To A Storage Container” filed Feb. 13, 2006.

This application is related to copending patent application entitled “Apparatus And Method For Controlling Access To Remotely Located Equipment”, application Ser. No. ______, filed ______ claiming priority to U.S. Provisional Patent Application Ser. No. 60/729,106 Filed Oct. 22, 2005, and copending patent application entitled “Apparatus And Method For Attaching An Electronic Module To A Lock Assembly” application Ser. No. ______, filed ______ claiming priority to U.S. Provisional Patent Application Serial No. claiming priority to U.S. Provisional Patent Application Ser. No. 60/772,700 filed Feb. 13, 2006.

### TECHNICAL FIELD

Apparatus and methods are provided to control and monitor access to a storage container and valuable objects contained therein. More particularly, apparatus and methods are provided to control access to both mobile and fixed storage containers and to monitor and record removal and return of valuable objects from such storage containers along with monitoring and recording possible tampering with the storage containers and/or valuable objects disposed therein.

### BACKGROUND

Modern, electronic vending machines often contain microprocessor based control systems, sometimes referred to as “vending machine controllers.” Such systems may be used to control, monitor and record detailed information about the state of an associated vending machine including, but not limited to, sales, cash received and paid out, errors, events, temperatures, inventory change, lock and unlock. A vending machine controller (VMC) may also control, monitor and record information from peripheral devices associated with functions such as coin acceptance, change giving, displays, credit cards and wireless transactions. The European Vending Association's Data Transfer Standard (“EVA-DTS”) and the National Automatic Merchandising Association's (NAMA) Multi-Drop Bus/Internal Communications Protocol (MDB/ICP or MDB) are widely used formats for collecting, recording, transmitting and auditing data associated with vending machines.

Advances in electronics are now enabling the use of computer controls and data acquisition systems within each vending machine. Some of the latest vending machines make it possible for vending operators to download data and information associated with sales, inventory, and equipment status on-site onto portable computers or transmit vending machine data and information to a central location such as a network operations center. Many vending machines include vending machine controllers based on the International Multi-drop Bus Interface Standards developed by the National Automatic Merchandising Association (NAMA).

A wide variety of electronic security systems including electromechanical locks and electronic keys have been developed for use in controlling access to remotely located equipment such as vending machines. Such electronic keys and electromechanical locks may include the use of one or more addressable switches. For example, Dallas Semiconductor manufactures and sells “one wire” addressable switches that allow peripherals to be identified by and communicate with electronic controllers and/or computers. Such addressable switches are sold under the registered trademark iButton.

### SUMMARY OF THE DISCLOSURE

In accordance with teachings of the present disclosure, apparatus and methods may be provided to monitor valuable objects in a storage container. For some embodiments, apparatus and methods may be provided to monitor and record removal and return of valuable objects stored in the container. The storage container and an associated electronic controller may be mounted in a service vehicle or at a fixed facility. The electronic controller may be operable to detect and record possible tampering with the storage container and/or valuable objects disposed within the storage container. The electronic controller may also be operable to control access to the storage container.

Technical benefits of the present disclosure may include eliminating or substantially reducing requirements for service personnel to return keys or other valuable objects to a central location for storage and safe keeping at the end of each shift. In large metropolitan areas significant amounts of nonproductive time may be saved by no longer requiring service personnel to return keys required for servicing remotely located equipment to a central location at the end of each daily work shift and to pick up the same keys or a different set of keys at the beginning of a new daily work shift.

A mobile storage container and associated electronic controller incorporating teachings of the present disclosure may provide satisfactory monitoring of valuable objects including, but not limited to, vending machine keys disposed in the storage container. As a result, service personnel may only be required to periodically return the storage container and/or valuable objects to a central location after weekly, monthly or even longer time periods.

All, some or none of these technical advantages may be present in various embodiments of the present disclosure. Other technical advantages will be readily apparent to one skilled in the art from studying the following figures, descriptions and/or claims.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 is a block diagram showing one example of a system for communicating information between remotely located equipment and a network operations center using various communication techniques including a handheld device;

FIG. 2 is a schematic drawing showing an isometric view of a service truck having an electronic controller and a mobile storage container incorporating teachings of the present disclosure;

FIG. 3A is a schematic drawing showing an isometric view of a panel having a plurality of receptacles and a plurality of inserts releasably engaged with respective receptacles in accordance with teachings of the present disclosure;

FIG. 3B is a schematic drawing in elevation showing a back view of the panel of FIG. 3A;

FIG. 4 is a schematic drawing showing an isometric view of one example of an insert incorporating various teachings of the present disclosure;

FIGS. 5A, 5B and 5C are schematic drawings showing isometric views of an insert being releasably engaged with a respective receptacle in accordance with teachings of the present disclosure;

FIG. 6 is a schematic drawing in section taken along lines 6-6 of FIG. 5C;

FIG. 7 is a schematic drawing showing an exploded isometric view of one example of an insert and receptacle incorporating teachings of the present disclosure;

FIG. 8 is a schematic drawing in section showing one example of a plunger which may be slidably engaged with an insert such as shown in FIG. 4; and

FIG. 9 is a schematic drawing showing an exploded isometric view of an addressable switch which may be mounted on a panel in accordance with teachings of the present disclosure.

### DETAILED DESCRIPTION OF THE DISCLOSURE

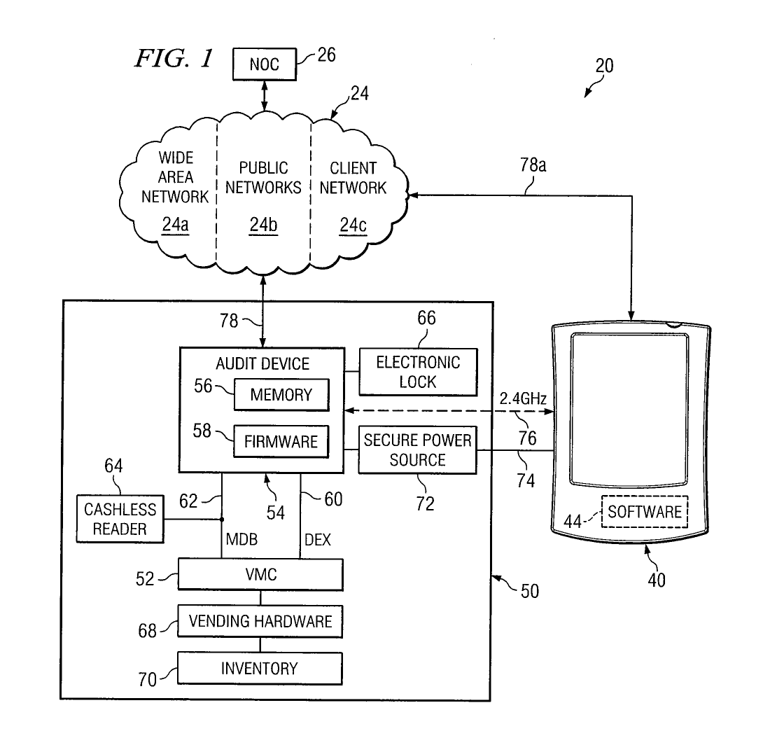

Preferred embodiments of the disclosure and various advantages are best understood by reference to FIGS. 1-9 wherein like numbers refer to same and like parts.

Various aspects of the present disclosure may be described with respect to remotely located equipment, mobile storage containers, mobile electronic controllers and/or handheld devices. However, various features and teachings of the present disclosure may be satisfactorily used with fixed storage containers having valuable objects disposed therein. Also, various embodiments of the present disclosure may not require the use of a handheld device.

The term “remotely located equipment” may be used in this application to refer to any automatic sales machine that allows payment to be exchanged for goods or services including, but not limited to, all types of vending machines, snack machines, beverage machines, automatic teller machines (ATMs), postage stamp dispensers, arcade machines, slot machines, laundry machines and car wash equipment. The term “remotely located equipment” may also be used to describe any type of equipment operated by use of a key or any enclosure, building or other secured space which may be opened using a key.

The term “wire-line transmissions” may be used to refer to all types of electromagnetic communications over wires, cables, or other types of conduits. Examples of such conduits include, but are not limited to, metal wires and cables made of copper or aluminum, fiber-optic lines, and cables constructed of other metals or composite materials satisfactory for carrying electromagnetic signals. Wire-line transmissions may be conducted in accordance with teachings of the present disclosure over electrical power lines, electrical power distribution systems, building electrical wiring, conventional telephone lines, ethernet cabling (10baseT, 100baseT, etc.), coaxial cables, T-1 lines, T-3 lines, ISDN lines, ADSL, etc.

The term “wireless transmissions” may be used to refer to all types of electromagnetic communications which do not require a wire, cable, or other types of conduits. Examples of wireless transmissions which may be used include, but are not limited to, personal area networks (PAN), local area networks (LAN), wide area networks (WAN), narrowband personal communications services (PCS), broadband PCS, circuit switched cellular, cellular digital packet data (CDPD), radio frequencies, such as the 800 MHz, 900 MHz, 1.9 GHz and 2.4 GHz bands, infra-red and laser.

The term “receptacle” may be used in this application to describe a socket, a chamber or any other type of cavity having an opening operable to receive an insert therein. Electrical contacts may be provided in the receptacle to communicate with an electronic controller.

The term “insert” may be used in this application to describe a plug, a fob, a pin or any other object which may be releasably engaged with a receptacle. Each insert may include an electronic identifier operable to communicate with an electronic controller when the insert is disposed within a respective receptacle. For some applications each receptacle and associated insert may be operable to communicate real time data with an electronic controller.

The term “electronic identifier” may be used in this application to refer to all types of electronic devices which may be securely engaged with a respective insert to communicate at least a unique identification such as a serial number associated with the respective insert. Examples of an electronic identifier may include, but are not limited to, an addressable switch, an RFID tag, a magnetic strip, or a smart card. One example of an addressable switch which will be discussed in more detail includes a one wire switch available from Dallas Semiconductor and sold under the registered trademark iButton. However, the present disclosure is not limited to addressable switches and/or one wire switches.

The term “electronic controller” may be used in this application to refer to an audit device, a general purpose computer or electronic processor having wireless transmission and/or wire-line transmission capabilities. An electronic controller may be operable to communicate real time data with a network operations center (NOC), remotely located equipment and/or handheld devices.

One of the technical benefits of the present disclosure may include the ability to easily replace an insert or fob if the “electronic identifier” should malfunction or if damage of any type occurs to the insert or fob without having to make any other changes to the storage container or electronic controller.

For some applications an electronic controller and/or handheld device may be operable to monitor, record, control and/or communicate a wide variety of transactions associated with a storage container having valuable objects disposed therein. The electronic controller and/or handheld device may be used to control access to a storage container having an electronic lock or electromechanical lock. The electronic controller may also notify a central location or a network operations center (NOC) when valuable objects are removed and/or returned and if possible tampering has occurred. The electronic controller and/or handheld device may be operable to record and communicate data related to date and time of removal and return of valuable objects from the storage container, location of an associated service vehicle, inventory level and status of tools and spare parts available in an associated service vehicle, location and/or various functions performed during servicing of remotely located equipment.

FIG. 1 is a schematic drawing showing a block diagram of portions of a system for collecting, storing and communicating data and other information associated with operation of remotely located equipment such as, but not limited to, vending machines. The data may include the status of various components associated with the remotely located equipment and transactions conducted at the remotely located equipment including, but not limited to, locking and unlocking a door to provide access to interior portions of the remotely located equipment. For some applications a mobile container incorporating teachings of the present disclosure may be satisfactorily used to store one or more keys used to obtain access to the remotely located equipment.

Data collecting, storing and communication system 20 may be satisfactorily used with vending machine 50 and other types of remotely located equipment. System 20 may include one or more handheld integration audit devices (handheld device) 40. Vending machine 50 may include vending machine controller (VMC) 52 operable to control and monitor various electronic components and mechanical components associated with vending machine 50. Vending machine 50 may also include audit device 54 having memory 56 and firmware 58.

Audit device 54 may be operable to obtain DEX data via DEX interface or communication link 60 from vending machine controller 52. Audit device 54 may also be operable to obtain multi-drop bus (MDB) data via MDB interface or communication link 62 from vending machine controller 52. Audit device 54 may also obtain MDB data from various peripherals including, but not limited to, cashless reader 64. Audit device 54 may archive or store the DEX data and MDB data in memory 56.

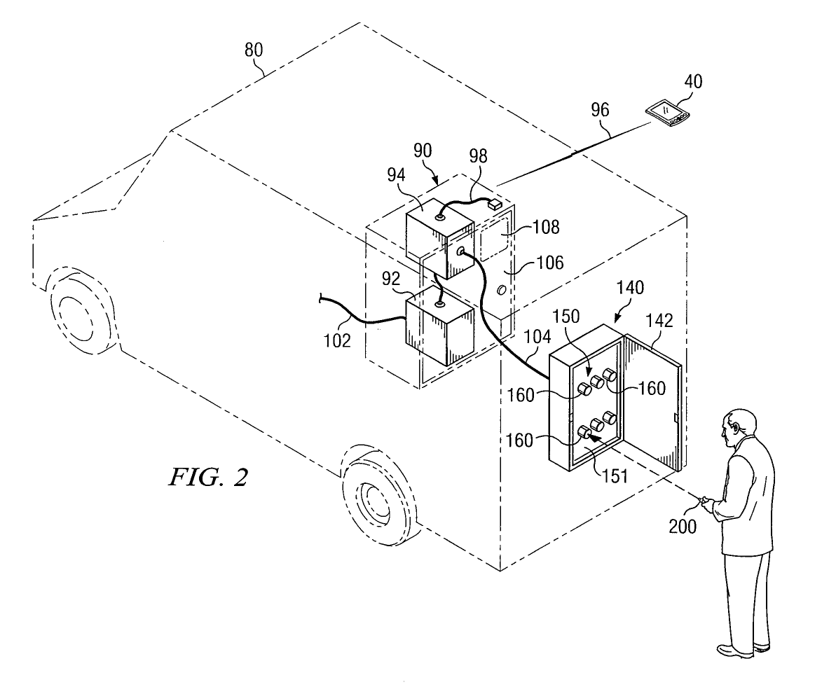

Audit device 54 of vending machine 50 may be operable to communicate with handheld device 40 and/or electronic controller 94 disposed within electronic enclosure 90. See FIG. 2. For some applications, handheld device 40, audit device 54 and/or electronic controller 94 may be equipped with one or more wireless transceivers. Examples of wireless communications that may be satisfactorily used with handheld device 40, audit device 54 and electronic controller 94 include, but are not limited to, Bluetooth, IEEE802.11a, IEEE802.11b and IEEE802.11g. For some applications handheld device 40, audit device 54 and electronic controller 94 may include respective Bluetooth transceivers (not expressly shown).

Communication link or interface 74 such as shown in FIG. 1 may allow communication of electrical signals between handheld device 40 and audit device 54. Also, link 74 may provide electrical power from secure power source 72 to handheld device 40. Alternatively, in the event of an emergency at vending machine 50, handheld device 40 may provide electrical power through link 74 to operate audit device 54. A similar link 98 may be provided between handheld device 40 and secure power source 92 disposed within electronic enclosure 90. See FIG. 2. Such wire-line connections provide multiple redundancy with respect to the data communication and supplying power required to operate handheld device 40, audit device 54 and/or electronic controller 94.

When handheld device 40 and audit device 54 communicate with each other over wire-line link 74 or wireless communication link 76, DEX data and MBD data stored in memory 56 may be transferred on demand to handheld device 40. In addition to DEX data and MDB data, audit device 54 may record and store other transactions or activities associated with vending machine 50. For example audit device 54 may record information concerning transactions such as the frequency, date and time and the identity of each engagement and disengagement of electronic lock 66. In addition, audit device 54 may record operational matters such as compressor failure, vend failures, inventory depletion, correct change events, user selected events as well as other data associated with modern electronic vending machine activities and transactions.

Vending machine 50 may include one or more hardware devices or peripheral devices operable to accept cash, noncash payment tokens and/or wireless payments. Cashless reader 64 may be representative of such hardware devices and peripherals. Cashless reader or cashless media device 64 may be operable to accept noncash payment tokens such as credit cards, RFID (Radio Frequency Identification Devices) or other media representative of noncash payment.

Vending machine 50 may include electronic lock 66 operably coupled with audit device 54. Electronic lock 66 may be commanded to engage or disengage in response to signals from audit device 54. Audit device 54 may operate electronic lock 66 by supplying appropriate power and/or digital control signals thereto. For example, audit device 54 may receive a command from handheld device 40 to initiate a sequence for unlocking electronic lock 66. Some vending machines and other types of remotely located equipment associated with data collecting, storing and communication system 20 may have only a mechanical locking device (not expressly shown) operated by a conventional key.

For some applications an electronic key (not expressly shown) may be used to initiate opening of an electronic lock. For such applications portions of an electronic reader (not expressly shown) may be disposed on exterior portions of vending machine 50. The electronic reader may be operable to respond to an electronic key and send an appropriate signal to audit device 54 to initiate a sequence for unlocking electronic lock 66.

The unlocking sequence may include a request from audit device 54 to electronic lock 66 to obtain a serial number associated with electronic lock 66. Audit device 54 may use a serial number or other information associated with electronic lock 66 to confirm that the electronic key is authorized for use in opening electronic lock 66 and associated vending machine 50. Handheld device 40 may also be used to initiate an unlocking sequence via audit device 54.

Vending machine 50 may include vending hardware 68 and inventory 70. Examples of vending machine hardware 68 may include, but are not limited to, one or more inventory dispensing apparatus, one or more coin acceptance and verification mechanisms, one or more bill acceptance and validation mechanisms or any other hardware device associated with vending machines. Vending machine 50 may also include secure power source 72 operably coupled to audit device 54. For some applications secure power source 72 may be used to provide power to audit device 54 in the event of power failure to vending machine 50 or at other selected time periods.

As shown in FIG. 1, secure power source 72 may be connected with handheld (handheld device) 40 via link or interface 74. Link or interface 74 may include a contact point or port external to vending machine 50 along with one or more suppression and power conditioning hardware devices (not expressly shown) to guard against electronic attack.

Handheld device 40 may be operable to communicate with audit device 54 and electronic controller 94 (see FIG. 2) using software applications 44. Communication techniques including personal area networks (PAN), local area networks (LAN) and wide area networks (WAN) may be used by an audit device, electronic controller and/or handheld device. The audit device, electronic controller and/or handheld device may be operable to provide location information using commercially available global positioning systems (GPS).

A mobile container and electronic controller incorporating teachings of the present disclosure may be installed within various types of service vehicles. For embodiments of the present disclosure such as shown in FIG. 2, service truck 80 may include electronic enclosure 90 and storage container 140. Electronic enclosure 90 may include various components such as secure power source 92 and electronic controller 94. Electronic enclosure 90 may include door assembly 108 operable to be locked and sealed to prevent unauthorized access by personnel using service vehicle 80. Door assembly 108 may have various types of locking mechanisms (not expressly shown) and/or sensors attached thereto and/or mounted thereon. Various types of enclosures which may be locked and sealed are commercially available for use as electronic enclosure 90.

For some applications, secure power source 92 may have characteristics and features similar to previously described secure power source 72. Electronic controller 94 may also have characteristics and features similar to previously described audit device 54. For some applications, various types of general purpose computers having both wireless and wire-line transmission capabilities may be satisfactorily used as electronic controller 94.

For some applications, door assembly 106 of electronic enclosure 90 may include window 108 covered with clear plastic material. One or more light emitting diodes (LEDs) may be visible through window 108 to allow monitoring the status of secure power source 92 and/or electronic controller 94. The plastic covering for window 106 may be operable to allow wireless transmissions such as Bluetooth therethrough. A reset button (not expressly shown) may also be available inside electronic enclosure 90 when door assembly has been opened by authorized personnel.

Various wire-line and/or wireless communication links may be established between electronic enclosure 90 and other components. For example, first cable or wire-line interface 102 may be provided to couple secure power source 92 with an electrical power distribution system (not expressly shown) associated with service vehicle 80. Second cable or wire-line interface 104 may be provided between electronic enclosure 90 and storage container 140. Cable 104 may be used to communicate data and other information between components disposed within storage container 140 and electronic controller 94. Cable 104 may also be used to provide electrical power from secure power source 92 to various components disposed within storage container 140.

Various types of commercially available enclosures and containers may be satisfactory used as storage container 140. For some applications storage container 140 may be generally described as a lockable vault or safe. For such applications storage container 140 may include door assembly 142 with various types of locking mechanisms (not expressly shown) and/or sensors (not expressly shown) attached thereto and/or mounted thereon. For some applications door assembly 142 may include mechanical locking mechanisms such as a conventional key and locking cylinder or a combination of tumblers and lock bolts associated with a conventional safe. One or more sensors (not expressly shown) may be attached with storage container 140 to indicate when door assembly 142 has been opened and closed.

For some applications, electronic enclosure 90 and storage container 140 may have similar types of mechanical locking mechanisms (not expressly shown) or electronic locking mechanisms (not expressly shown). For other applications, electronic enclosure 90 and storage container 140 may have substantially different locking mechanisms. For example, storage container 140 may have an electronic lock operable to be opened in response to signals sent from handheld device 40 via electronic controller 94. For this same application, electronic enclosure 90 may have a mechanical lock which may be opened only by a mechanical key and/or a combination maintained by personnel located at a service center.

Electronic controller 94 may be operable to record and store a wide variety of transactions and other activities associated with storage container 140, valuable objects disposed therein, electronic enclosure 90 and/or other components associated with service vehicle 80. For some applications, electronic controller 94 may also be operable to communicate with network 24 in the same manner as previously described with respect to communication between audit device 54 and network 24. For example, electronic controller 94 may maintain a log or record of transactions such as the date, time and number of valuable objects removed from and returned to storage container 140. Electronic controller 94 may also be operable to monitor and record possible tampering with the contents of storage container 140 and/or electronic enclosure 90. Electronic controller 94 may also record the date, time and identity of each handheld device 40 which may request disengagement of an electronic lock associated with either storage container 140 or electronic enclosure 90.

For some applications electronic controller 94 may be operable to monitor and record the status of various components associated with service vehicle 80. An antenna or other suitable interface (not expressly shown) may be provided to supply data from a global positioning system (GPS) to electronic controller 94 so that geographic locations may be recorded and/or transmitted to network operations center 24 along with the previously discussed data. As a result, a service center having access to network operations center 24 may be able to more effectively manage service vehicles to provide optimum maintenance and servicing of remotely located equipment and minimize requirements for service vehicles to return to the service center.

Handheld device 40 and associated software 44 may provide a user interface operable to indicate the status of electronic controller 94, electronic enclosure 90 and/or storage container 140. Handheld device 40 may also be operable to send signals via electronic controller 94 using wireless link 96 to disengage and engage an electronic lock (not expressly shown) associated with storage container 140. Wireless link 96 may have characteristics similar to previously described wireless link 76.

Wire-line link 98 may be provided between electronic controller 94 and the exterior of electronic enclosure 90. Various types of cables (not expressly shown) may be used to couple handheld device 40 with wire-line link 98. As previously noted with respect to link 74 in FIG. 1, such wire-line connections provide multiple redundancy with respect to data communication and supplying power required to operate handheld device 40, audit device 54 and/or electronic controller 94.

For some applications an RFID reader or other type of electronic reader (not expressly shown) may be attached to link 98. Alternatively, a wireless RFID reader or other wireless electronic readers (not expressly shown) may be used to communicate with electronic controller 94 via wireless link 96. As a result, electronic controller 94 may be used to record usage of tools and changes in repair part inventory carried in service vehicle 80. Such data may be transferred real time to a service center (not expressly shown) via network 24 or may be downloaded when vehicle 80 returns to a service center after daily, weekly or even longer time periods.

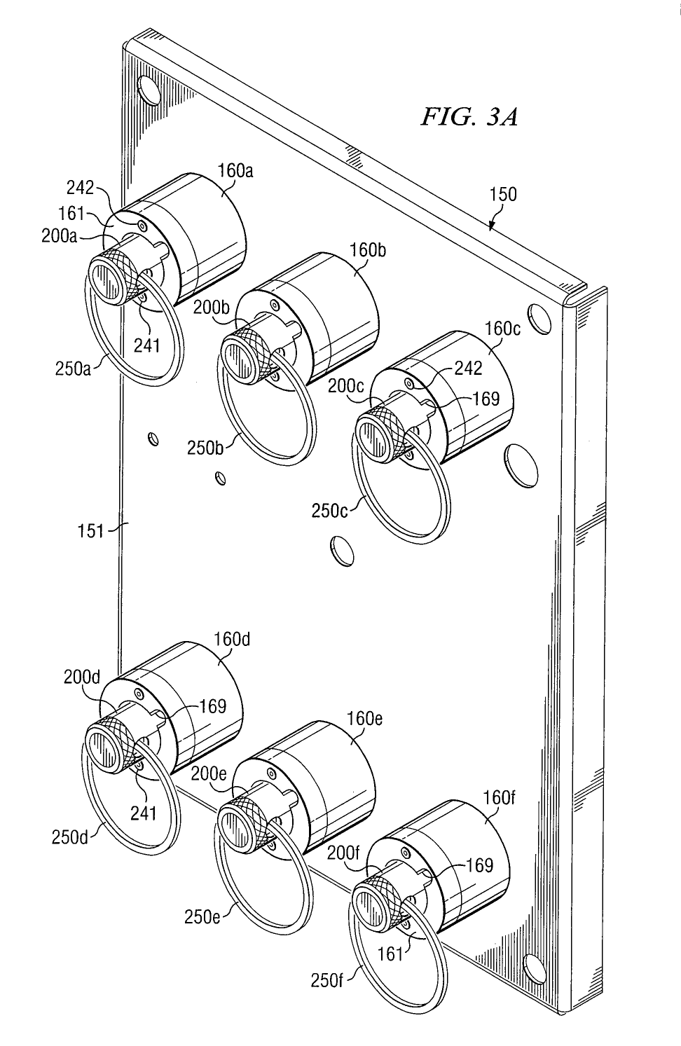

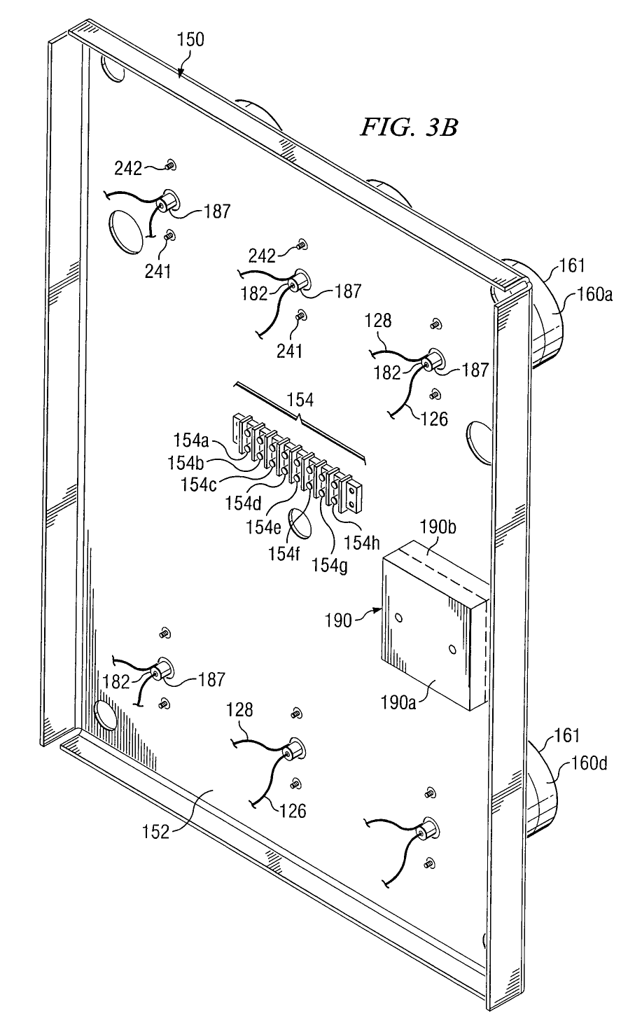

For some applications panel 150 such as shown in FIGS. 3A and 3B may be disposed within interior portions of storage container 140. Various types of mechanical fasteners (not expressly shown) may be satisfactorily used to engage panel 150 with interior portions of storage container 140. For embodiments such as shown in FIGS. 2, 3A and 3B, a plurality of receptacles 160 may be securely engaged with front surface or first surface 151 of panel 150. Receptacles 160 may sometimes be generally described as “sockets.” Electronic controller 94 may receive signals from panel 150 to indicate when inserts or valuable objects are engaged with and disengaged from receptacles 160.

One or more sensors operable to detect possible tampering with storage container 140 and/or valuable objects disposed therein may also be provided. For example, back surface or second surface 152 of panel 150 may include a sensor operable to indicate any attempt to remove panel 50 from interior portions of storage container 140. For embodiments such as shown in FIGS. 3B and 9, housing with sensor 192 disposed therein may be securely attached with second surface 152, various types of mechanical fastening techniques (not expressly shown) and/or bonding techniques may be used. For some applications housing 190 may include base 190b and covering 190a. Both base 190b and covering 190a may include cut out or recessed portion 194 having dimensions and configurations compatible with disposing sensor 192 therein.

For some applications sensor 190 may be an addressable switch available from various companies. For such applications a signal wire and a ground wire (not expressly shown) may extend from contacts 196 and 198 of sensor 192 through notch 194 formed in housing 190. Various details associated with sensor 192 will be discussed later in more detail.

Various electrical connections may be provided on back surface or second surface 152 of panel 150. For embodiments such as shown in FIG. 3B, a plurality of electrical contacts 154 may be disposed on second surface 152 of panel 150. A plurality of electrical wires may extend from each socket or receptacle 160 to respective contacts 154. A pair of wires (not expressly shown) may also extend from sensor 192 via notch 194 in housing 190 to respective pairs or sets of contacts 154. See FIG. 9. Second cable 104 from electronic enclosure 94 may include a pair of wires (not expressly shown) engaged with respective contacts 154.

For purposes of describing various features of the present disclosure, respective sets of contacts 154 have been designated as a, b, c, d, e, f, g and h. For some applications electrical wires such as respective signal wire 126 and ground wire 128 extending from end 182 of each socket or receptacle 160a-160e may be engaged with respective sets of contacts 154a-154e. The wires extending from housing 190 may be engaged with contacts 154g. The wires extending from second cable 104 may be engaged with contacts 154h. Signal wires 126 may be used to communicate data and other information between electronic controller 94, respective socket 160a-160e and/or associated insert 200.

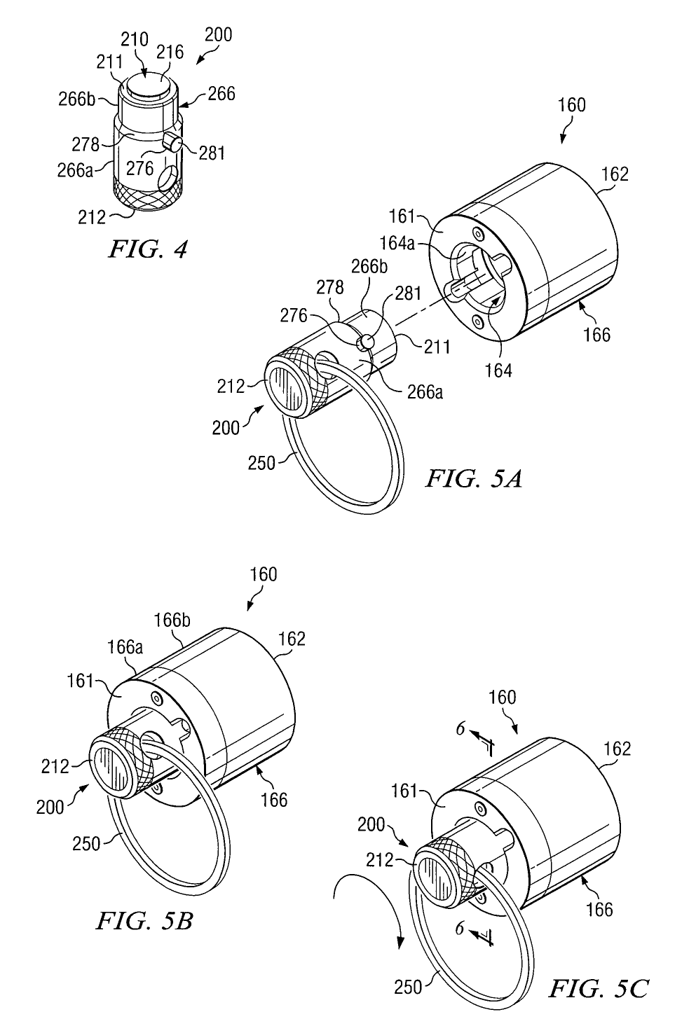

One example of an insert or plug which may be releasably disposed within each receptacle 160 is shown in FIGS. 4, 5A, 5B, 5C and 6. For some applications receptacles 160 may have similar configurations, dimensions and functions. For such applications all inserts 200 may have similar configurations, dimensions and functions. As a result, each insert 200 may be releasably engaged with any receptacle 160. For other applications, each receptacle and each insert may have unique configurations and/or unique dimensions such that each insert may be releasably engaged with only a specific receptacle (not expressly shown).

For purposes of describing various features of the present invention receptacles 160 as shown in FIGS. 3A and 3B have been designated 160a, 160b, 160c, 160d, 160e and 160f. Inserts 200 have been designated 200a, 200b, 200c, 200d, 200e and 200f and key rings 250 have been designated 250a, 250b, 250c, 250d, 250e and 250f for the same reason. However, for embodiments such as shown in FIGS. 3A and 3B each receptacle 160 may have substantially the same configuration and dimensions and each insert 160 may have substantially the same configuration and dimensions. Key rings 250 may also have substantially the same configuration and dimensions satisfactory for attachment with each insert 200.

For embodiments such as shown in FIGS. 3A and 3B, six (6) receptacles 160 are shown securely engaged with first surface 151 of panel 50. Respective inserts 200a-200f are shown engaged with respective receptacles or sockets 160a-160f. Various types of valuable objects may be securely engaged with each insert 200a-200f. For some applications, respective key ring 250a-250f may be securely engaged with respective insert 200a-200f. Keys (not expressly shown) associated with various types of mechanical locking mechanisms may also be engaged with each key ring 250a-250f. For such applications inserts 200a-200f may be referred to as “fobs” when key rings and keys are attached thereto. However, a wide variety of valuable objects other than keys and key rings may be securely engaged with inserts formed in accordance with teachings of the present disclosure.

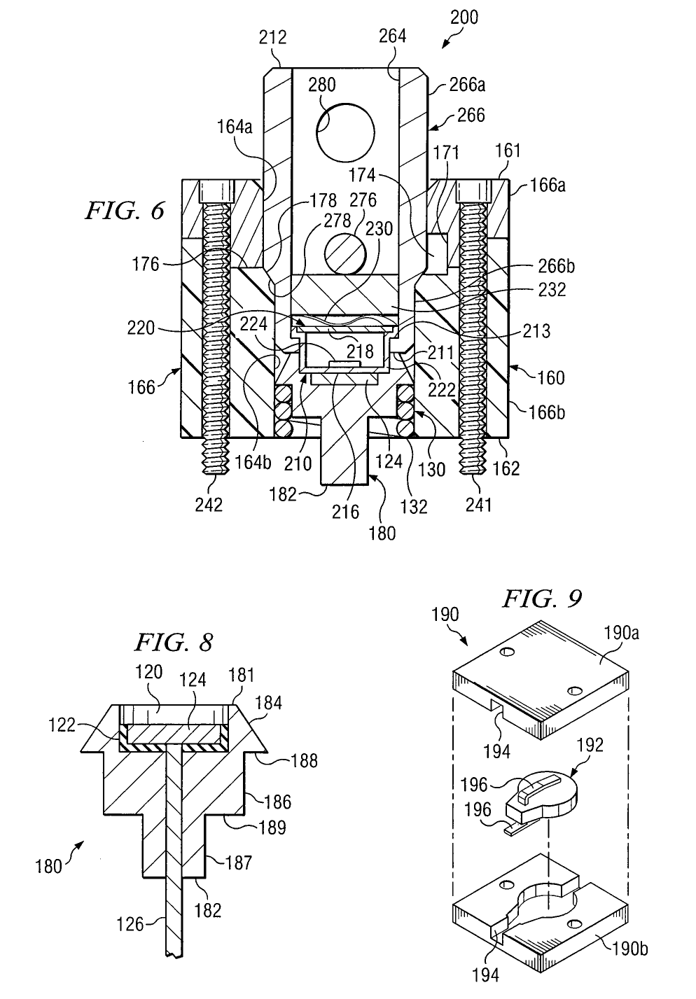

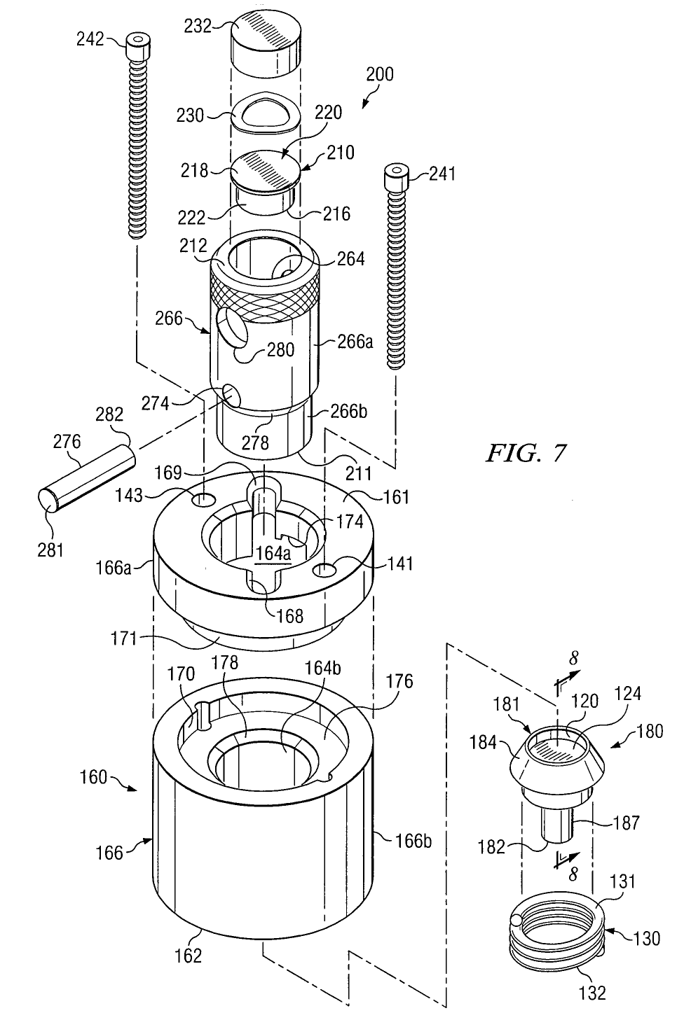

Each insert 200a-200f may include electronic identifier 210. For some applications an addressable switch such as a “one-wire” addressable switch may be satisfactorily used as electronic identifier 210. Examples of such electronic identifiers include, but are not limited to, iButtons available from Dallas Semiconductor. As shown in FIGS. 6 and 7 electronic identifier 210 may include a generally hollow enclosure or “can” formed from electrically conductive material such as stainless steel. Each may have a signal or data contact 214 corresponding with one surface of the can or enclosure and a second electrical contact or ground 216.

For embodiments such as shown in FIGS. 3A, 4, 5A, 5B, 5C, 6 and 7 each insert 200 may include first end 211 and second end 212. Exterior dimensions and configuration of each insert 200 may be selected to be compatible with interior dimensions and configuration of respective longitudinal bores 164 formed in receptacles 160.

For some applications each insert 200 may be generally described as having generally cylindrical body 266 with longitudinal bore 264 extending therethrough. Cylindrical body 266 may include first segment 266a and second segment 266b. The outside diameter of first segment 266a may be selected to be compatible with the inside diameter of longitudinal bore segment 164a formed in each receptacle 160. The outside diameter of second segment 266b may be selected to be compatible with the inside diameter of longitudinal bore second segment 164b formed in each receptacle 160.

For embodiments such as shown in FIGS. 4, 5A, 6 and 7 generally tapered shoulder 278 may be formed on the exterior portion of each insert 200 to provide a transition between the outside diameter of first segment 266a and the outside diameter of second segment 266b. Corresponding tapered annular shoulder 178 may be formed on interior portions of each receptacle 160 proximate associated longitudinal bore segment 164b. See FIGS. 6 and 7. As a result, when insert 200 is placed into respective receptacle 160, first end 211 and associated second segment 266b may pass through both longitudinal bore segment 164a and longitudinal bore segment 164b until tapered shoulder 278 on the exterior of insert 200 contacts tapered shoulder 178 of respective receptacle 160.

For embodiments such as shown in FIGS. 6 and 7, each receptacle 160 may include first end 161 and second end 162 with longitudinal bore 164 extending therethrough. The interior dimensions and configuration of each longitudinal bore 164 may be selected to be compatible with exterior dimensions and configuration associated with inserts 200. For some applications each receptacle may be described as having generally cylindrical body 166 with longitudinal bore 164 extending therethrough. For purposes of manufacture and assembly, cylindrical body 166 may be formed from first component 166a and second component 166b.

The segment of longitudinal bore 164 disposed within first component 166a has been designated 164a. The segment of longitudinal bore 164 disposed within second component 166b has been designated as 164b. The inside diameter of longitudinal bore segment 164a may be larger than the inside diameter of longitudinal bore segment 164b. As previously noted, each insert 200 may also include first segment 266a having an outside diameter corresponding approximately with the inside diameter of longitudinal bore segment 164a and second segment 266b having an outside diameter corresponding with the inside diameter of longitudinal bore segment 164b.

Second component 166b may include enlarged inside diameter portion 170 operable to receive reduced outside diameter portion 171 extending from first component 166a. See FIGS. 6 AND 7. Reduced outside diameter portion 171 may be sized to fit within enlarged outside diameter portion 170. Recess 174 may be formed within longitudinal bore 164 intermediate first end 161 and second end 162 by cutting out one or more segments in reduced outside diameter portion 171. See FIGS. 6 and 7. Annular shoulder 176 may be formed on the interior of second component 166b between enlarged inside diameter portion 170 and longitudinal bore segment 164b.

A pair of longitudinal grooves 168 and 169 may be formed in opposite sides of longitudinal bore segment 164a. For some applications, each insert 200 may include a pair of openings or holes 274 which extend laterally through outside diameter portion 266a proximate tapered shoulder 278. One opening 274 is shown in FIG. 7. Respective pin 276 may extend through each pair of openings 274 and associated longitudinal bore 264. See FIGS. 4, 5A, 6 and 7. The length of each pin 276 may be selected to be greater than the outside diameter of first segment 266a of each insert 200. As a result first end 281 and second end 282 of each pin 276 form a respective first projection and second projection extending from opposite sides of associated insert 200. Projections or ends 281 and 282 may be slidably disposed within longitudinal grooves 168 and 169.

Each insert 200 may be slidably disposed within longitudinal bore 164 of receptacles 160 until tapered shoulder 278 formed on the exterior of body 266 engages tapered shoulder 178 formed on the interior of the associated longitudinal bore 164. A pair of recesses or cutouts 174 may be formed in reduced outside diameter portion 171 of first component 166a proximate respective longitudinal grooves 268 and 269. As a result, insert 200 may then be rotated to allow projections 281 and 282 from associated pin 276 to be disposed within recess 174 after contact between respective tapered shoulders 178 and 278. Such rotation of insert 200 releasably engages projections 281 and 282 with respective recesses 174. This engagement between each insert 200 and associated receptacle 160 prevents vibration and other movement associated with service vehicle 80 from disconnecting or disengaging one or more inserts 200 from associated receptacles 160.

As shown in FIGS. 4, 6 and 7, electronic identifier 210 may be inserted into longitudinal bore 264 such that electrical contact or signal contact 216 will preferably extend from first end 211 of insert 200. Second electrical contact or ground contact 218 will preferably engage lip or annular shoulder 213 formed on the inside diameter of longitudinal bore 264 proximate first end 211. For some applications electronic identifier 210 may be generally described as a “sealed can” defined in part by lid or top 220 and base 222. Various types of insulating material including, but not limited to, a polypropylene grommet (not expressly shown) may be disposed between lid 220 and base 222. Various types of electronic devices sometimes referred to as “chip” 224 may be disposed within base 222 opposite from first electrical contact or signal contact 216. For many applications electrical device 224 may include a unique unalterable electronic device. The unalterable electronic address may serve as a “key” or electronic identifier. Base 222 may include a flange which engages annular shoulder 213.

Biasing means such as wave spring 230 may be disposed within longitudinal bore 264 proximate second electrical contact 218. Spacer disk or retainer disk 232 may next be inserted into longitudinal bore 264. Pin 276 may then be inserted through respective holes 274 to securely retain spacer 232, wave spring 230 and electronic identifier 210 within longitudinal bore 264 with first electrical contact or signal contact 216 extending from first end 211.

For some applications, plunger 180 may be disposed within longitudinal bore segment 164b adjacent to second end 162 of receptacle 160. See FIGS. 6, 7 and 8. Each plunger 180 may include respective first end 181 and second end 182. For embodiments such as shown in FIGS. 6 and 7, first end 181 of plunger 180 may be slidably engaged with first end 211 of the associated insert 200. Second end 182 of each plunger 180 may extend from second end 162 of associated receptacle 160. See FIGS. 3B and 6.

Plunger 180 may be described as having a generally cylindrical configuration having a complex exterior profile. Plunger 180 may include tapered exterior surface 184 extending from first end 181. Reduced outside diameter portion 186 may be formed adjacent to tapered surface 184. The change from tapered surface 184 to reduced outside diameter portion 186 may form first annular shoulder 188. The dimensions of annular shoulder 188 may be selected to be compatible with the dimensions of associated biasing means 130. See FIGS. 6 and 7. Further reduced outside diameter portion 187 may be formed on the exterior of plunger 180 adjacent to second end 182. The difference between outside diameter portion 186 and outside diameter portion 187 may form second annular shoulder 189. The dimensions of annular 189 are preferably selected to be larger than associated holes formed in panel 150. As a result, only end 182 and reduced diameter portion 187 of plungers 180 will extend through associated openings in panel 150. See FIG. 3B.

For some applications a pair of longitudinal openings 141 and 143 may be formed in each receptacle 160 extending from first end 161 through second end 162. The dimensions and configuration of longitudinal openings 141 and 143 are preferably selected to be compatible with associated mechanical fasteners 241 and 242. As a result, each receptacle 160 may be placed on first surface 151 of panel 150 with second end 182 of associated plunger 180 extending through an associated opening or hole. Mechanical fasteners 241 and 242 may be inserted through respective longitudinal passageways 141 and 143 to engage corresponding openings in panel 150. As shown in FIG. 3B end 182 of each plunger 180 and portions of associated mechanical fasteners 241 and 242 preferably extend through panel 150.

First end 181 of plunger 180 may include cavity 120 disposed therein. The dimensions of cavity 120 may be selected to form end 181 with satisfactory surface area for contact with adjacent portions of end 211 of insert 200. One or more layers 122 of insulating material (see FIG. 8) may be disposed within cavity 120. Various types of electrical insulating material may be satisfactory used to form insulating layer 122.

Electrical contact 124 may then be disposed on top of insulating material 122 with electrical wire or signal wire 126 extending therefrom. Electrical contact 124 may be generally described as a relatively thin circular disk having a surface area approximate equal with the surface area of signal contact 216. Wire 126 may provide electrical power to “chip” or electrical device 224 via contacts 216 and 124. For some applications a battery (not expressly shown) may be included with electrical device 124.

Biasing means 130 may sometimes be described as a coiled spring. First end 131 of biasing means 130 may be sized to engage annular shoulder 189 formed on the exterior of plunger 180. Second end 132 of biasing means 130 may be rest upon adjacent portions of first surface 151 of panel 150. First biasing means 230 and second biasing means 130 may cooperate with each other to maintain secure electrical contact between signal contacts 216 and 124 even when vehicle 80 is moving.

Each insert 200 may include a second pair of openings 280 formed adjacent to second end 212. See FIGS. 3A, 6 and 7. Openings 280 may be sized to receive respective key rings 250. Various types of materials such as high grade stainless steel, titanium and/or other material may be satisfactory used to form each insert 200 and associated key rings 250. Such materials may be selected to minimize or prevent tampering or if tampering occurs to indicate tampering with insert 200.

Although the present disclosure and its advantages have been described in detail, it should be understood that various changes, substitutions and alterations may be made thereto without departing from the spirit and scope of the disclosure as defined by the following claims.

What is claimed is:

1. A system for monitoring and controlling access to valuable objects comprising:
at least one panel having a plurality of receptacles;
at least one insert operable to be releasably engaged with at least one of the receptacles;
each insert having a respective electronic identifier; and
an electronic controller operably coupled with the panel to monitor and record when each insert is engaged with and disengaged from one of the receptacles.

2. The system of claim 1 further comprising at least one valuable object securely engaged with each insert.

3. The system of claim 1 further comprising a plurality of keys securely engaged with at least one insert.

4. The system of claim 1 further comprising:
an addressable switch securely engaged with the panel; and
the addressable switch operably engaged with the electronic controller to monitor possible tampering with the panel.

5. The system of claim 1 further comprising the panel disposed within a container having a generally hollow interior with at least one door operable to control access to the panel disposed within the container.

6. The system of claim 5 further comprising:
the door operable to be locked in a closed position to prevent unauthorized access to the panel disposed within the container; and
the electronic controller operable to monitor and record each time the door of the container is locked and unlocked.

7. The system of claim 6 further comprising at least one electrical cable extending between the container and the electronic controller to allow the electronic controller to monitor and control access to the container.

8. The system of claim 1 wherein each receptacle further comprises:
a socket having a first end and a second end with a generally hollow bore extending longitudinally therethrough;
the first end of the socket sized to receive at least one insert therein; and
the second end of the socket operable to communicate with the electronic identifier when the at least one insert is releasably engaged with the socket.

9. The system of claim 8 further comprising:
a pair of longitudinal grooves formed within the longitudinal bore of the socket;
the longitudinal grooves sized to receive respective projections extending from the at least one insert;
an annular recess formed in the longitudinal bore intermediate the first end and the second end of the socket; and
the annular recess intersecting with the longitudinal grooves to allow rotation of the at least one insert to securely engage the projections from the at least one insert in the annular recess.

10. The system of claim 8 further comprising:
a first spring disposed in the at least one insert to bias the electronic identifier toward the second end of the socket; and
a second spring disposed in each socket to bias a plunger to make electrical contact with the electronic identifier when the at least one insert is releasably engaged with the sockets.

11. A system for monitoring and controlling access to a storage container with valuable objects disposed therein comprising:
the storage container including a housing having a hollow interior with at least one door;
a lock on the door to prevent unauthorized access to the storage container;
at least one panel disposed within the storage container having a plurality of receptacles in which respective inserts may be releasably engaged;
a respective electronic identifier disposed within each insert;
each receptacle operable to electrically contact the electronic identifier when one of the inserts is releasably disposed within the receptacle; and
each receptacle operable to communicate with an electronic controller when one of the inserts has been engaged with the receptacle and disengaged from the respective receptacle.

12. The system of claim 11 wherein the electronic controller further comprises an audit device.

13. The system of claim 11 further comprising:
the electronic controller disposed in an electronic cabinet having a door; and
the electronic controller operable to monitor and record when the door of the electronic cabinet is locked and unlocked.

14. The system of claim 11 further comprising the electronic controller operable to monitor and record each time the door of the container is opened and closed.

15. The system of claim 11 further comprising an electrical cable extending between the storage container and the electronic controller to allow the electronic controller to monitor and control access to the storage container.

16. The system of claim 11 further comprising:
a first wireless transceiver disposed within the storage container and a second wireless transceiver disposed within the electronic controller; and
the first wireless transceiver and the second wireless transceiver operable to communicate information between the storage container and the electronic controller.

17. The system of claim 11 further comprising a local area network (LAN) transceiver disposed within the electronic controller and operable to transmit data concerning the storage container to a handheld device.

18. The system of claim 11 further comprising:
a wide are network (WAN) transceiver disposed within the electronic controller; and
the WAN transceiver operable to transmit data between the electronic controller and a network operations center.

19. The system of claim 11 further comprising a spring disposed within each receptacle to maintain secure contact between the electronic reader and the electronic identifier attached to the insert when the insert is releasably engaged with the receptacle.

20. The system of claim 11 wherein each electronic identifier further comprises an addressable switch.

21. The system of claim 11 wherein each insert further comprises a fob having a key ring with at least one key securely engaged with the key ring.

22. The system of claim 11 further comprising the electronic controller operable to unlock the door of the container in response to a signal from a handheld device.

23. The system of claim 11 further comprising each receptacle operable to communicate the respective identity of an insert when the insert is releasably engaged with the receptacle.

24. A system for controlling and monitoring access to a mobile storage container disposed within a service vehicle and valuable objects disposed within the mobile storage container comprising:
an electronic enclosure disposed within the service vehicle;
the electronic enclosure operably coupled with the mobile storage container;
an electronic controller disposed within the electronic enclosure;
the mobile storage container having a plurality of receptacles operable to be releasably engaged with respective inserts;
each insert having a respective unique, electronic identifier;
each receptacle operable to communicate a signal to the electronic controller when one of the inserts is engaged with the receptacle and when the one insert is removed from the receptacle; and
the electronic controller operable to identify the respective insert disposed in the receptacle.

25. The system of claim 24 further comprising releasable engagement between each insert and the respective receptacle operable to prevent vibration associated from movement of the service vehicle from disengaging the insert from the associated receptacle.

26. The system of claim 24 further comprising:
a respective plunger slidably disposed in each receptacle; and
each plunger having a respective electrical contact operable to engage an electrical contact associated with the respective insert disposed in the receptacle.

27. The system of claim 26 further comprising:
each plunger having insulating material disposed between the respective electrical contact and adjacent portions of the plunger;
a signal wire attached to and extending from the respective electrical contact; and
each signal wire operable to communicate signals between the electronic controller and the respective insert disposed in the receptacle.

28. A method to monitor and control access to inserts disposed within a container comprising:
releasably engaging each insert with a respective receptacle disposed within the container; and
sending a signal from a respective electronic identifier disposed in each insert to an electronic controller to indicate when the insert is installed within the receptacle and to indicate when the insert has been removed from the receptacle;

29. The method of claim 28 further comprising:
transmitting a first signal from the container to the electronic controller when a door of the container is unlocked and opened;
transmitting a second signal from the container to the electronic controller when the door is closed and locked;
recording at the electronic controller when the door to the container is open and when the door to the container is closed; and
recording at the electronic controller when each insert is engaged and disengaged from one of the receptacles.

30. The method of claim 28 further comprising:
transmitting a first signal to the electronic controller when a door associated with remotely located equipment is unlocked and opened;
transmitting a second signal to the electronic controller when the door of the remotely located equipment is closed and locked; and
recording on the electronic controller when the door of the remotely located equipment is opened and when the door of the remotely located equipment is closed.
